(19) United States
(12) Patent Application Publication
(10) Pub. No.: US 2019/0341671 A1
(43) Pub. Date: Nov. 7, 2019

(54) Precision adjustment antenna mount apparatus and alignment method

(71) Applicant: Winegard Company, Burlington, IA (US)

(72) Inventor: Timothy John Conrad, Mt. Pleasant, IA (US)

(21) Appl. No.: 16/401,864

(22) Filed: May 2, 2019

Related U.S. Application Data
(60) Provisional application No. 62/665,844, filed on May 2, 2018.

(51) Int. Cl. H01Q 1/12

(52) U.S. Cl. CPC H01Q 1/1264; H01Q 1/1207

(57) ABSTRACT

An antenna adjustment apparatus adapted to fit between an antenna mount and an antenna support frame for fine positioning a directional antenna in the azimuth and elevation directions. Two motors for controlling movement in the azimuth and elevation directions are mounted within a housing. The motors are pivotally connected and controlled through a control component which carries signals and power for controlling the operation of the motors. In one embodiment, the apparatus includes at least upper and lower housing mounted to each other for rotational movement. Through the adjustment apparatus, a directional antenna can be rapidly positioned in both the azimuth and elevation directions from a remote location.

### RELATED APPLICATIONS

This application claims the benefit of U.S. Provisional Patent Application No. 62/665,844, filed May 2, 2018, which is incorporated herein in its entirety by reference.

### BACKGROUND

### Field

The present disclosure relates to a positioning device for an antenna and, more particularly, to a fine peak adjustment apparatus capable of precisely re-positioning a directional antenna, such as a satellite dish, that is no longer in alignment.

### General Background

Setting up a satellite dish or other directional antennae to receive television, communication (such as broadband and internet) or other signals requires the precise positioning and aiming. With a satellite dish antenna, satellites are “parked” in geosynchronous orbit, typically 22,300 miles above the equator, and travel at the exact same rate as the earth's rotational speed so they appear stationary. To obtain a good signal, the antennae, such as a satellite dish, must be pointed precisely (within 2 degrees in all directions and as little as 0.2-0.05 degrees for some satellite internet providers) and directly at the satellite (the “look angle”), with no obstructions between the two. A poorly aimed antenna may drastically degrade performance of the antenna system. For example, results of mis-aiming an antenna may be described in terms of satellite link interference, off-axis interference into other satellites, transmission interference, degraded reception, and/or the like. The interference arises in part because the less an antenna is pointing directly at the intended target, the more it is pointing at an unintended target such as an unintended satellite. Moreover, signal strength at the receiving antenna is reduced when the aiming is off by even a small amount.

In a typical installation procedure, the antenna is generally pointed at the desired azimuth and elevation angle to find the desired signal. Most receivers provide information to help guided the installer. In one example an installer will attempt to minimize a bit rate error generated as a satellite signal is received to help point the antenna properly. Once the antenna is generally aligned with the proper signal the second phase of pointing the antenna is “peaking up”. In this step the antenna, such as a satellite dish, is manually moved in from side-to-side in one degree of freedom (such as azimuth) about a desired center location to identify points at either side of the movement where the incoming signal has the same low quality. These points then identify a mid-point at which the signal is strongest. The mounting assembly is manually manipulated, loosened and tightened to set the ideal azimuth, and then elevation, for the antenna. For a satellite dish, this initial aiming process can take up to an hour to complete. The process is often made more problematic where in some situations, the only means to judge signal quality is through electronics inside a building and remote from the antenna, or in some cases through an audible signal from the transceiver.

With exposure to the elements, particularly wind and gravity, as well as to external vibrations, the antenna system eventually moves out of optimal alignment. Over time the quality of the signal deteriorates until it becomes necessary to re-point or peak the antenna. It is then necessary to repeat the manual peaking up process described above. The manual adjustment process is labor-intensive which makes the process time-consuming and expensive if performed by a technician provided by the antenna service provider.

Consequently, there is a need for a fine peak adjustment apparatus that simplifies the peaking up or antenna re-alignment process. There is also a need for such a fine peak adjustment apparatus that can be implemented in new antenna installations as well as retro-fit for existing installations. The present disclosure addresses this need with an adjustment apparatus that is mounted between the mounting assembly and the antenna support frame.

### SUMMARY

This disclosure involves an apparatus and method for fine peaking of antennas including satellite dish antennas, such as single frequency, narrowband frequency, and broadband frequency as well as other directional antennas. The method includes aligning an antenna by rotating a lower housing and upper housing, where the lower housing rotates with respect to a mounting plate in an elevation and azimuth angle to bring a signal to a signal level peak and the upper housing rotates along a gear ring in an elevational and azimuth angle to further refine the signal level peak.

In one embodiment, a lower and upper housing are rotationally connected where the lower housing is connected to a mounting plate and the upper housing is connected to an antenna attachment. The housing contains at least two actuators where movement of the actuators cause the lower and upper housing to rotate and change the elevation and azimuth angles. The changes in the angles are effected by pivoting of the lower and upper housing with respect to the mounting plate, the antenna attachment, and each other. The complete housing is placed between an antenna support frame and an antenna mount. The elevational and azimuth angles are currently rotated between 2 and 15 degrees.

In another embodiment, a housing contains a base plate pivotally connected to an x-axis plate where the x-axis plate is additionally pivotally connected to a y-axis plate. Two actuators are contained within the housing, where movement of the actuator attached to the base plate rotates the x-axis plate in an azimuth angle and movement of the actuator attached to the y-axis plate rotates the y-axis plate in an elevational angle. When the housing is placed between a mounting point of an antenna and antenna support frame, the azimuth and elevational angles of the antenna can be adjusted.

The disclosed apparatus may also include a counterbalancing spring where in some situations the spring will be disposed outside of the upper and lower housing and in other situations the spring will be disposed between the x-axis plate and the y-axis plate within the housing.

Control of the actuators is effected through a control component, where the control component may be integrally connected within the apparatus or may be within its own enclosure either within or outside of the housing. In some embodiments, the control component will be within the base plate. In other embodiments, the control component will be within the antenna attachment. The control component powers and controls the actuators. The control component may be self-contained in that can be remotely activated to perform re-adjustment of the azimuth and elevation angles. The control component may additionally incorporate a wireless communication feature that allows communication with a remote device such that the antenna system can be adjusted without the need to be at the location of the antenna. Further, the control component may also incorporate electronics and software capable of reading a signal from a transceiver. For example, a transceiver can determine signal strength or quality and use that information to determine the optimal elevational- and azimuth-angles using the same iterative process that is ordinarily done manually.

### BRIEF DESCRIPTION OF THE DRAWINGS

The accompanying drawings, which are incorporated in and constitute a part of this specification, illustrate embodiments of the disclosure and, together with the general and detailed descriptions of the disclosure appearing herein, serve to explain the disclosed principles.

FIG. 1A is a perspective view of the attachment of a directional antenna and a mounting base of disclosed embodiment one.

FIG. 1B is a perspective view of the attachment of a directional antenna and a mounting base of disclosed embodiment two.

FIG. 2A is a right side schematic side section view of disclosed embodiment one.

FIG. 2B is a left side schematic side section view of disclosed embodiment one.

FIG. 3 is a top view of the mounting plate (3A) and antenna attachment (3B) of disclosed embodiment one.

FIG. 4 is a perspective view of embodiment two.

FIG. 5 is a section view of FIG. 4.

FIG. 6 is an exploded view of embodiment two.

### DETAILED DESCRIPTION

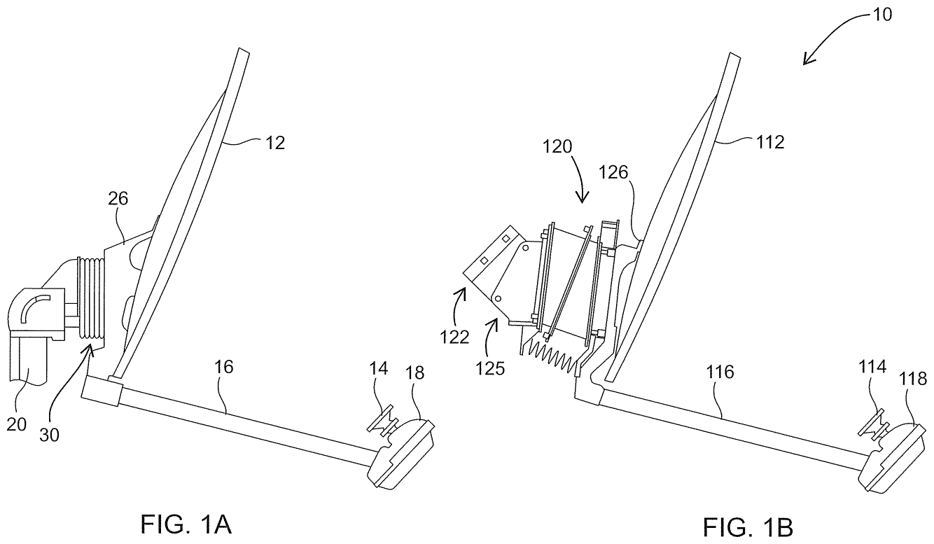

In FIG. 1, the major components of two embodiments of the adjustment apparatus [A,B] are disclosed (30/130). A typical satellite antenna system 10, such as the two shown in FIG. 1 includes a reflector or dish 12,112 that directs a signal from a satellite to a feed horn 14,114. The feed horn 14, 114 is mounted on a boom 16, 116 projecting from and in fixed relation to the dish 12, 112 to receive signals reflected by the dish, which is often parabolic shaped. Feed horn 14, 114 transmits the received signal to a transceiver 18, 118 that includes electronics for converting and transmitting the incoming signal to the receiver, modem, TV decoding box or broadband internet.

As shown in the embodiment of FIG. 1A, the antenna system is mounted on a base 20 that can be a pole, bracket, panel or other structure configured to rigidly support the antenna system on the ground or on a building. A mounting assembly 22, 122 permits adjustment of the elevation and azimuth angles of the dish 12 and feed horn 14. A typical mounting assembly of the antenna system includes an arrangement of slotted plates and brackets fixed by bolts that permit movement of the dish 12, 112 in at least two degrees of freedom to point the dish at the desired satellite. In the previous art, mounting plate 25 is ordinarily directly fastened to the support frame 26 supporting the dish 12 and the boom 16. Although the figures show use of the currently disclosed device with a satellite dish, any type of directional antenna, such as a Yagi® antenna, quad antenna, billboard antenna, or helical antenna, is contemplated. Use on a satellite dish is not meant to be limiting.

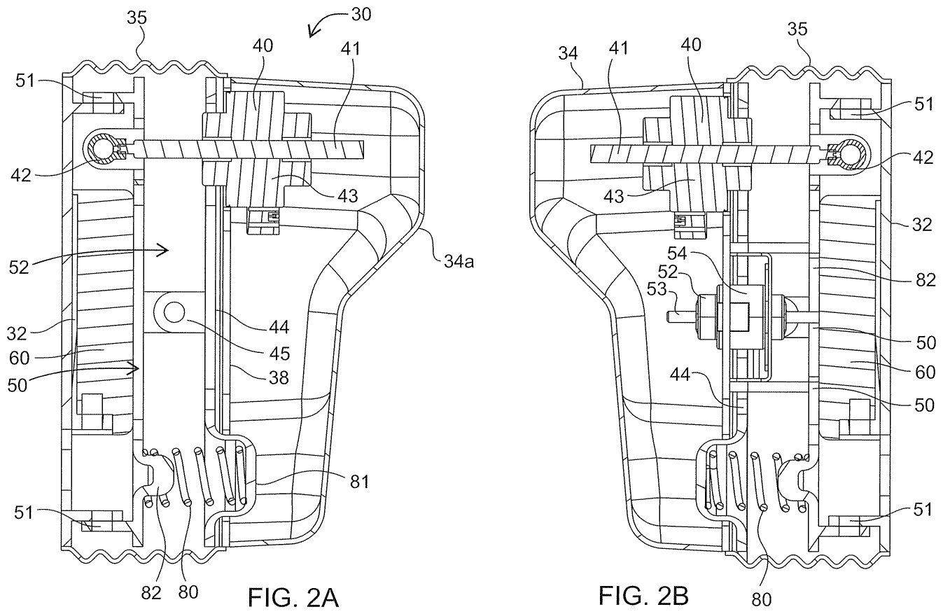

As shown in FIG. 2, in the first embodiment, adjustment apparatus 30 fits between mounting plate 25 and support frame 26. The adjustment apparatus 30 includes an adjustment apparatus base plate 32. In other embodiments, such as the second embodiment, the adjustment apparatus base plate and mounting plate will be integrally connected. FIG. 2 demonstrates the adjustment apparatus 30 enclosed within a main cover 35 and operating along an elevation axis 36. The main cover 35 is flexible to permit movement along the elevation angle 36 relative to the adjustment apparatus base plate 32. In one embodiment, the main cover is a bellows-configured cover with circumferential corrugations that allow the cover to flex in multiple degrees of freedom. It can be appreciated that this configuration of the adjustment apparatus 30 allows it to be integrated into a new antenna installation or retrofit to an existing installation. It can further be appreciated that the configuration of the adjustment apparatus base plate 32 and top surface 36a, and particularly of the mounting holes in the respective components, can be adjusted as necessary to accommodate any particular mounting assembly 22 and support frame 26.

In the embodiment of FIG. 2, adjustment apparatus 30 includes actuators that are used to incrementally move the lower y-axis plate 36 relative to the adjustment apparatus base plate 32 in the two degrees of freedom required for re-alignment of the antenna, namely the azimuth and elevation angles. The adjustment apparatus includes a Y-axis actuator 40 that is operable to pivot the y-axis plate, and thus the antenna 12, in the elevation angle degree of freedom. The y-axis actuator 40 includes a spindle 41 that is anchored at one end 42 to an x-axis plate 50, which is itself mounted to the adjustment apparatus base plate 32. The spindle 41 can be a threaded shaft or lead screw, and the actuator can include a motor 43 that rotates about and translates along the threaded shaft of the spindle 41. The motor 43 is mounted to a y-axis plate 44 so that the plate moves with the motor 43 as it travels along the spindle 41. The y-axis plate 44 is fastened to the top surface 34a of antenna attachment 34 so that the cover moves with the y-axis plate. The y-axis plate 44 is pivotably mounted by a pair of flanges at an elevation pivot axis 45 so that as the motor 43 moves along the spindle 41 and the y-axis plate 44 moves with the motor, the y-axis plate 44 is pivoted about the elevation pivot axis 45. This movement produces the elevation angle adjustment for the dish 12.

The y-axis plate 44 is pivotably mounted to an x-axis plate at the elevation pivot axis 45. The x-axis plate 50 is pivotably mounted to the adjustment apparatus base plate 32 by flanges at an x-axis pivot 51. The adjustment apparatus 30 further includes an x-axis actuator 52 (FIG. 2) that is operable to adjust the azimuth angle of the dish 12. Like the y-axis actuator 40, the x-axis actuator 52 includes an x-axis actuator spindle 53 and an x-axis actuator motor 54 slidably mounted on the spindle and fastened to the x-axis plate 50. The x-axis actuator spindle 53 is anchored to the adjustment apparatus base plate 32 (not shown) in a similar manner as the y-axis actuator spindle 41 is anchored to the x-axis plate 50. The x-axis actuator thus operates in the same manner as the y-axis actuator, namely by movement of the x-axis actuator motor 54 along the x-axis actuator spindle 53. As the x-axis actuator motor 54 moves, it carries the x-axis plate 50 with it, causing the plate to pivot about the x-axis pivot 51. As the x-axis plate 50 pivots, it pivots the y-axis plate 44 with it, and ultimately the lower y-axis plate 36 mounted to the y-axis plate, thereby adjusting the antenna dish 12.

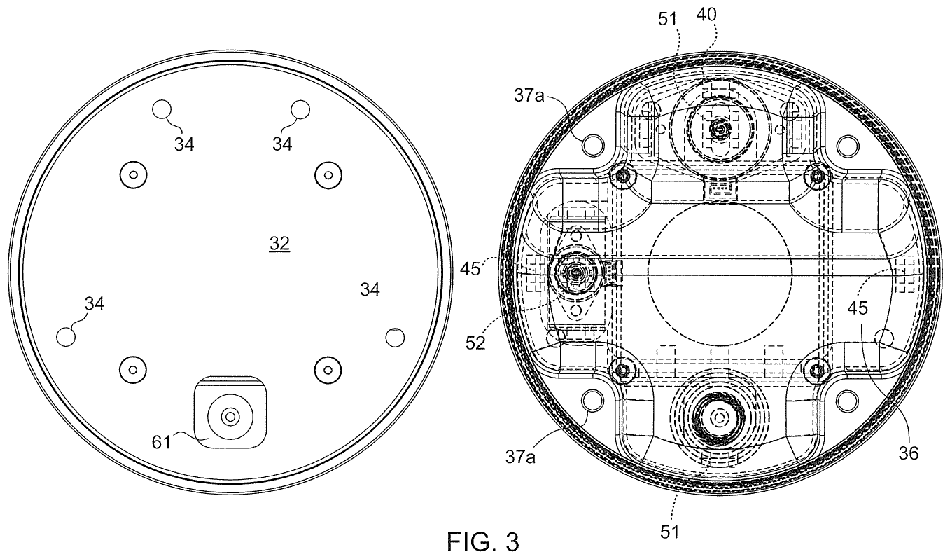

FIG. 3 demonstrates further detail in how top surface 34a of antenna attachment 34 defines attachment holes 37a for receiving a fastener, such as a bolt or screw, to mount the support frame 26 to the top surface so that the support frame can move with the adjustment apparatus. FIG. 3 also demonstrates mounting holes 34 arranged to receive bolts to fasten to the mounting plate 25

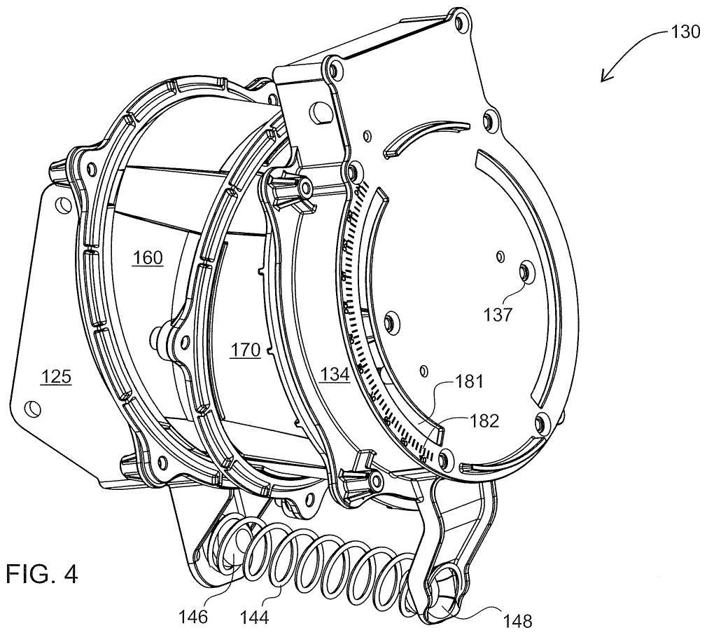

In a second example of the disclosed adjustment apparatus, demonstrated generally in FIG. 4, adjustment apparatus 130 consists of two housing pieces 160 (bottom), 170 (top) mounted to each other for rotational movement about the elevation and azimuth angles. A mounting plate 125 is adapted to secure the adjustment apparatus upon a desired antenna mount. In the present embodiment, the mounting plate 125 is adapted to mount upon the end of a mounting pole or mast via fasteners such as a nut and bolt (or slots). In this embodiment, mounting plate 125 is integral to adjustment apparatus 130.

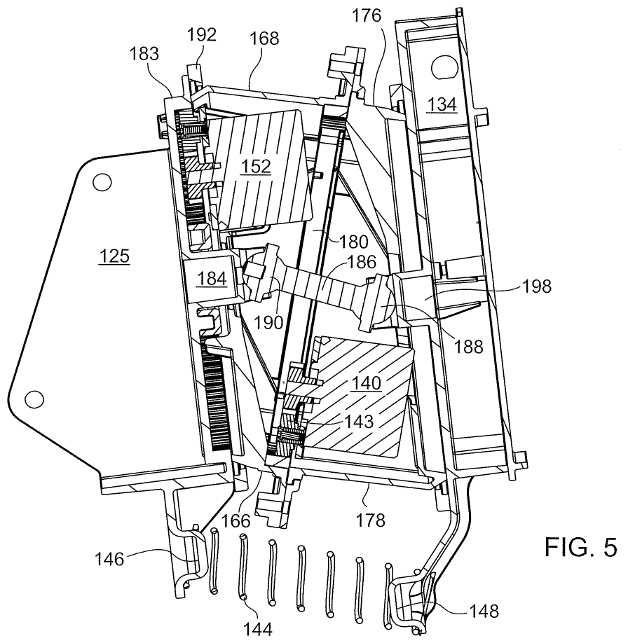

As shown in FIG. 5, top surface 180 of mounting plate 125 has pivot point 184. Top surface 180 of mounting plate connects with bottom housing 160 via known connections such as a flange 192. However, use of a flange is not meant to be limiting and other types of connections are contemplated. In this embodiment, bottom housing 160 is wedge shaped with an open front 162, open back 164, narrow side 166 and wide side 168. A y-axis actuator 152 is connected to the top surface 180 of mounting plate 125. Y-axis actuator 152 (FIG. 5) is mechanically operable to adjust the elevation and azimuth angles of the dish 12. Y-axis actuator 152 includes a Y-axis actuator spindle 153 and a Y-axis actuator motor 154 slidably mounted on y-axis actuator spindle 153. Y-axis actuator motor may be attached to a gear ring 180, such that y-axis motor rotates around open back 164. In one embodiment, y-axis actuator motor 154 is a rotary motor. However, other types of motors, such as stepper motors are contemplated.

Similarly to bottom housing 160, top housing 170 has an open front 172, open back 174, narrow side 176 and wide side 178. In other embodiments, top and bottom housing will be circular, rectangular or square, necessitating that a narrow side and a wide side not exist. In one embodiment, top housing 170 is also a wedge. Top housing 170 is attached to bottom housing 160 through gear ring 180 and one or more flanges. However, the demonstration of flanges in FIG. 4 is not meant to be limiting and any attachment known in the art which will allow rotation is contemplated. Top housing 170 and bottom housing 160 are mounted to each other to allow for rotational movement along the x-axis. Open fronts 162, 172 extend substantially parallel to each other. In FIGS. 4-6, open fronts 162 and 172 are shown as substantial complements of one another. However, this is not required and open fronts 162 and 172 could be of widely varying and different sizes.

Open back 174 of top housing 170 connects to antenna attachment 134 via known connections such as a flange 194. Top surface 196 of antenna attachment 134 also has a pivot point 198. Receiving rod 186 rotatably fits within pivot points 184 and 198. In certain embodiments, pivot points 180 and 198 are ball sockets and rod 186 has a top 188 and bottom 190 ball. In many embodiments, rod 186 will be a double ball anti-twist rod. Rod 186 is rotably attached to bottom housing 160 at pivot point 184 such that as y-axis actuator motor 154 moves, bottom housing 160 moves and pivots about pivot point 184. As the bottom housing 160 pivots, it pivots top housing 170 with it, thereby adjusting the elevation and azimuth angles of the antenna dish 12.

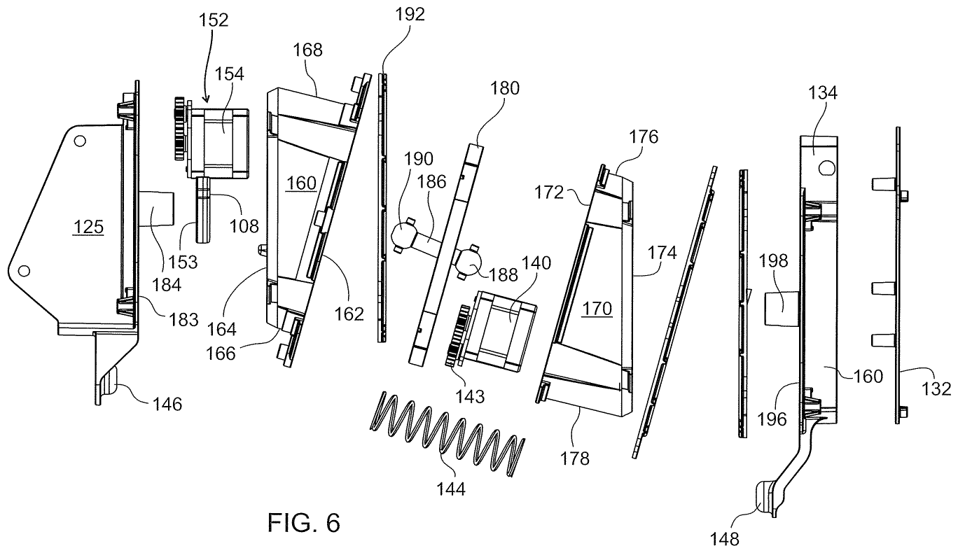

In top housing, an x-axis actuator 140 is connected to gear ring 180. X-axis actuator 140 (FIGS. 5-6) is operable to further adjust the elevation and azimuth angle of the antenna 12. As is demonstrated in FIGS. 5-6, x-axis actuator 140 includes an x-axis actuator rotatable motor 143. X-axis actuator motor 143 is mounted to gear ring 180 such that top housing 170 moves with the x-axis actuator rotatable motor 143. Rod 186 is rotably attached to top housing 170 at pivot point 198 so that as x-axis actuator motor 143 rotates, top housing 170 is pivoted about the horizontal axis thus adjusting the elevation and azimuth angle of the antenna 12.

Top housing 170 is attached to the support frame 126 of dish 12 through antenna attachment 134. As is understood by one of skill in the art, the attachment of top housing 170 to antenna attachment 134 and attachment of antenna attachment 134 to support frame 126 is not meant to be limiting and can be accomplished by means known in the art. For example, as shown in FIG. 4, these can include attachment holes 137 arranged to receive bolts to fasten the adjustment apparatus 130 to support frame 126. Antenna attachment 134 may include a scale slot 181 and markings 182 such that rough azimuth adjustment can be easily effected by rotation of antenna attachment 134 about the mounting point prior to the final tightening of the fasteners.

An advantage of the second embodiment is that the rotatable attachment of top housing 170 to bottom housing 160 allows for angled plates as the mounting plate and antenna attachment, similar to swash plates in hydromechanical motors. This allows for increased static load capacity.

In all embodiments, the adjustment apparatus can be configured to permit angular adjustments of ±15° of the elevation and azimuth angles. In the first embodiment, this is controlled through the y-axis plate 44 and pivot 45, and the x-axis plate 50 and pivot 52. In embodiment 2, control is through the gear ring 180 and pivot 184 and pivot 186. Since the adjustment apparatus is intended for fine adjustments of the antenna position, larger angular ranges are generally not necessary. However, larger angular adjustments can be achieved by appropriate modifications.

In certain embodiments, spindles 41, 53, 153 will have an edge hard stop. Hard stop 108 is demonstrated in FIG. 6. A hard stop provides that the static load caused by an excessive wind condition is transferred to the hard stop, thereby shielding the actuators from damaging loads.

In either embodiment, the adjustment apparatus can further include a control component housed within its own enclosure. In the first embodiment, control enclosure 60 mounted to the base plate 32. The control component 60 includes the electronics and power supply necessary to power and control actuators 40, 52. In the embodiment of FIG. 3, access to control component 60 is provided through an opening 61 in the base plate 32, such as for connection to an external power supply or external control device. In the embodiment of FIGS. 4-6, control component 160 is housed in its own enclosure within antenna attachment 134. In this embodiment, as is best shown in FIG. 6 access to control component 160 is provided through openings in top plate 132. Control component 60, 160 may include a printed circuit board and it is contemplated that the control component 60, 160 may be self-contained in that can be remotely activated to perform re-adjustment of the azimuth and elevation angles. The control component may additionally incorporate a wireless communication feature that allows communication with a remote device such that the antenna system can be adjusted without the need to be at the location of the antenna.

The control component may also incorporate electronics and software capable of reading a signal from a transceiver 18, 118 (FIG. 1). The transceiver can determine signal strength or quality and use that information to determine the optimal elevational- and azimuth-angles using the same iterative process that is ordinarily done manually. The present disclosure further contemplates that the control component 60, 160 may be integrated into a service provider system that can remotely operate the control component to re-align the antenna 12. Although not meant to be limiting, control component 60, 160 may incorporate features that monitor the orientation of the antenna and/or the signal strength/quality and then communicate to the service provider when an adjustment is needed, even before the owner of the antenna is aware of a problem.

The disclosed actuators can be linear or rotary actuators of various types. However, since the actuators must maintain the set orientation of the antenna 12 under all conditions, the actuators must have a static load capability sufficient to withstand expected environmental loading, such as from high winds. Similarly, the pivot points and particularly the stiffness, clearance and tolerance of the components forming the pivot axes, must be calibrated to minimize wind load deflection without unduly increasing the actuator force requirements. Smaller actuators may be provided with certain adjustments to the actuator control.

As can be appreciated wind loads on the adjustment apparatus are a concern. In one embodiment, the pitch of the threads on the actuators can be calibrated to hold the actuator position up to a predetermined wind speed. At wind speeds above that predetermined limit, controller 60, 160 can be operable to back drive one or both actuators. The adjustment apparatus 30 may be provided with hard stops so that the static load caused by the excessive wind condition is transferred to the hard stop, thereby shielding the actuators from damaging loads. Once the excessive wind conditions ends, the controller can direct the actuators to their last known position.

In order to assist the actuators of the adjustment apparatus 30, 130 in withstanding high wind loads, the adjustment apparatus may be provided with a counter-balance spring. In the first embodiment, spring 80 is positioned between the y-axis plate 44 and the x-axis plate 52. The two plates may be provided with a cup 81 and protrusion 82 to center and retain the spring 80 between the plates. The spring 80 is arranged opposite the y-axis actuator 40. An additional counter-balance spring may be provided between the x-axis plate 50 and positioned opposite the x-axis actuator 52. The spring absorbs loads applied to the lower y-axis plate 38 due to the weight of the antenna. The spring thus allows minimizing the size and force required for the y-axis actuator 40.

In the second embodiment, a spring 144 may also be attached between mounting plate 125 and antenna attachment 134 outside of top housing 170 and bottom housing 160. Mounting plate 125 and antenna attachment 134 can include protrusion 146, 148 to center and retain spring 144. Nevertheless, protrusions 146, 148 are examples only and spring 144 may be attached to the adjustment apparatus using any method known in the art.

Different embodiments of the adjustment apparatus have been described. Nevertheless, modifications and alternations will occur to others upon a reading and understanding of this specification. This specification is intended to include all such modifications and alterations insofar as they come within the scope of the appended claims or the equivalents thereof.

1. A positioning system for an antennae comprising:
a mounting plate connected to a lower housing;
a antenna attachment connected to an upper housing, wherein the lower housing and upper housing are rotationally coupled;
an actuator fixedly attached to the mounting plate;
a gear ring between the lower housing and upper housing;
an actuator fixedly attached to the gear ring;
wherein movement of the actuator attached to the mounting plate rotates the lower housing and the upper housing in an elevational and an azimuth angle;
wherein movement of the actuator attached to the gear ring rotates the upper housing in an elevational and an azimuth angle.

2. The system of claim 1, wherein the mounting plate is connected at an angle to an antenna mount opposite the connection to the lower housing.

3. The system of claim 1, wherein the antenna attachment is connected at an angle to an antenna support frame opposite the connection to the upper housing.

4. The system of claim 1, wherein the mounting plate and the antenna attachment each further comprise a pivot point.

5. The system of claim 4, wherein the upper housing and lower housing are rotationally coupled by a receiving rod.

6. The system of claim 5, wherein the receiving rod is rotationally coupled at the pivot points.

7. The system of claim 1, wherein the actuators are stepper motors.

8. The system of claim 1, wherein the rotation of the elevational angle is between 2 and 15 degrees.

9. The system of claim 1, wherein the rotation of the azimuth angle is between 2 and 15 degrees.

10. The system of claim 1, wherein the mounting plate actuator has a hard stop.

11. The system of claim 1, further comprising a counterbalance spring coupled between the mounting plate and the antenna attachment.

12. A positioning system for an antennae comprising:
a base plate;
a x-axis plate;
a y-axis plate,
wherein the base plate and the x-axis plate are pivotably coupled and the x-axis plate and y-axis plate are pivotably coupled;
an actuator fixedly attached to the base plate;
an actuator fixedly attached to the y-axis plate;
wherein movement of the actuator attached to the base plate rotates the x-axis plate in an azimuth angle, further wherein rotation of the x-axis plate rotates the y-axis plate;
wherein movement of the actuator attached to the y-axis plate rotates the y-axis plate in an elevation angle.

13. The system of claim 12, wherein the actuators are stepper motors.

14. The system of claim 12, wherein the rotation of the elevational angle is between 2 and 15 degrees.

15. The system of claim 12, wherein the rotation of the azimuth angle is between 2 and 15 degrees.

16. The system of claim 12 further comprising a cover attached to the base plate, wherein the cover covers the actuators.

17. The system of claim 12 further comprising a spring, wherein the spring is disposed between the x-axis plate and the y-axis plate.

18. The system of claim 12 further comprising a control component, wherein the control component powers and controls the movement of the actuators.

19. The system of claim 18 wherein the control component is remotely activated.

20. A method of aligning an antenna, comprising the steps of
rotating a lower housing with respect to a mounting plate to bring a signal to an elevational angle and an azimuth angle signal level peak;
rotating an upper housing with respect to the lower housing to bring a signal closer to a the elevational angle and azimuth angle signal level peak;
wherein the lower housing and upper housing are rotationally connected.

21. The method of claim 20 wherein the upper and lower housing fit between an antenna mount and an antenna support frame.

22. The positioning system of claim 1 wherein the antenna is a directional antenna.

23. The positioning system of claim 22 wherein the directional antenna is a satellite dish, a Yagi® antenna, quad antenna, billboard antenna, or helical antenna.
